(19) United States
(12) Patent Application Publication
(10) Pub. No.: US 2025/0104021 A1
(43) Pub. Date: Mar. 27, 2025

(54) FRAMEWORK TO PRIORITIZE PART DISPATCH FOR DEVICES BASED ON REAL-TIME DEGRADATION RATE

(71) Applicant: Dell Products L.P., Round Rock, TX (US)

(72) Inventors: Parminder Singh SETHI, Punjab (IN); Daniel L. HAMLIN, Round Rock, TX (US); Ibrahim SAYYED, Georgetown, TX (US); Lakshmi Saroja NALAM, Bangalore (IN); Vasanth SATHYANARAYANAN, Bangalore (IN)

(73) Assignee: Dell Products L.P., Round Rock, TX (US)

(21) Appl. No.: 18/472,848

(22) Filed: Sep. 22, 2023

(51) Int. Cl. G06Q 10/20; G06Q 10/083

(52) U.S. Cl. CPC G06Q 10/20; G06Q 10/0838

(57) ABSTRACT

An information handling system may include at least one processor; and a memory having instructions coded thereon that are executable for: receiving information regarding dispatch of replacement parts for a plurality of devices; determining a degradation rate for each device based on a weighted tree for each device, wherein the device is a root node of the weighted tree, wherein components of the device are child nodes of the weighted tree, and wherein alerts associated with each component are leaf nodes of the weighted tree; determining a device threshold for each device; and dispatching parts based on the weighted trees and the device thresholds.

### TECHNICAL FIELD

The present disclosure relates in general to information handling systems, and more particularly to predicting failures in information handling resources and intelligently dispatching replacement parts.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in handling information systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems include a variety of parts that may fail over time. Accordingly, a manufacturer or vendor of information handling systems may deliver various parts to customers through a part dispatch system. For purposes of this disclosure, the term “manufacturer” should be understood to include manufacturers of information handling systems or components thereof, vendors, OEMs, etc.

The timeline for part dispatch is generally determined depending on the severity of the issue and the entitlement or services purchased by the customer.

A part dispatch may typically take between four hours to two days. Existing approaches to part dispatch have a significant drawback, however, in that there is a considerable risk that the system's condition will worsen before the customer receives the replacement part. As a result, the customer's productivity may suffer, negatively impacting their business and creating a poor customer experience.

For example, consider the following example timeline for replacement of a part. On March 20, an issue is identified in a device, and a part dispatch case is created on the same day. On the next day, March 21, the part is dispatched to the customer, and so the customer will receive the part on March 24. However, in the meantime, the existing part is continuing to malfunction, and the heath of the device containing the part deteriorates. This continues to affect the performance of the device, as well as any other dependent components. This results in the complete degradation of the device, which stops working before the customer receives the part.

Embodiments of this disclosure provide improved techniques for part dispatch prioritization to avoid situations like the above.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with part dispatch in information handling systems may be reduced or eliminated.

In accordance with embodiments the present of disclosure, an information handling system may include at least one processor; and a memory having instructions coded thereon that are executable for: receiving information regarding dispatch of replacement parts for a plurality of devices; determining a degradation rate for each device based on a weighted tree for each device, wherein the device is a root node of the weighted tree, wherein components of the device are child nodes of the weighted tree, and wherein alerts associated with each component are leaf nodes of the weighted tree; determining a device threshold for each device; and dispatching parts based on the weighted trees and the device thresholds.

In accordance with these and other embodiments of the present disclosure, a method may include an information handling system receiving information regarding dispatch of replacement parts for a plurality of devices; the information handling system determining a degradation rate for each device based on a weighted tree for each device, wherein the device is a root node of the weighted tree, wherein components of the device are child nodes of the weighted tree, and wherein alerts associated with each component are leaf nodes of the weighted tree; the information handling system determining a device threshold for each device; and the information handling system dispatching parts based on the weighted trees and the device thresholds.

In accordance with these and other embodiments of the present disclosure, an article of manufacture may include a non-transitory, computer-readable medium having computer-executable code thereon that is executable by a processor of an information handling system for: receiving information regarding dispatch of replacement parts for a plurality of devices; determining a degradation rate for each device based on a weighted tree for each device, wherein the device is a root node of the weighted tree, wherein components of the device are child nodes of the weighted tree, and wherein alerts associated with each component are leaf nodes of the weighted tree; determining a device threshold for each device; and dispatching parts based on the weighted trees and the device thresholds.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a high-level example of how part dispatch may be prioritized, in accordance with embodiments of the present disclosure;

FIG. 3 illustrates how backend components interface with the service environment, in accordance with embodiments of the present disclosure;

FIG. 4 illustrates the decomposition of a device into a weighted tree, in accordance with embodiments of the present disclosure;

FIG. 5 illustrates the application of weights to a weighted tree, in accordance with embodiments of the present disclosure;

FIG. 6 illustrates a data set for health descriptors, in accordance with embodiments of the present disclosure;

FIG. 7 illustrates example pseudocode, in accordance with embodiments of the present disclosure;

FIG. 8 illustrates example pseudocode, in accordance with embodiments of the present disclosure;

FIG. 9 illustrates a non-optimized example of part dispatch, in accordance with embodiments of the present disclosure; and

FIG. 10 illustrates an optimized version of the part dispatch from FIG. 9, in accordance with embodiments of the present disclosure.

### DETAILED DESCRIPTION

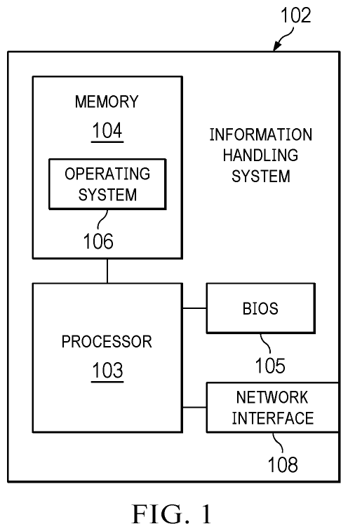

Preferred embodiments and their advantages are best understood by reference to FIGS. 1 through 10, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

As discussed above, embodiments of this disclosure may improve upon for part dispatch existing systems prioritization. Part dispatch of each device may be prioritized using the real-time degradation rate of each device and actual failure threshold values. The degradation rate of the device may be calculated using a weighted tree and device health descriptors, as described in more detail below. Once the dispatch priority has been established, the parts may be physical dispatched (e.g., mailed, sent via courier, hand-carried, etc.) to the location of the device.

The actual threshold value of the device may be calculated using factors that affect the time required to gather, dispatch, and fix the parts such as: the time required for the manufacturer to dispatch parts, the time required for the dispatched part to reach the customer destination, the time required for the onsite technician to reach the destination, the time required to replace parts by the technician, etc.

Once the actual threshold value is determined, the devices that require part dispatch may be prioritized based on the factors such as the following parameters using a multiple linear regression: the workload of the device, any redundancy in the configuration (e.g., the device having redundant disks, etc.), the actual threshold value, and the degradation rate.

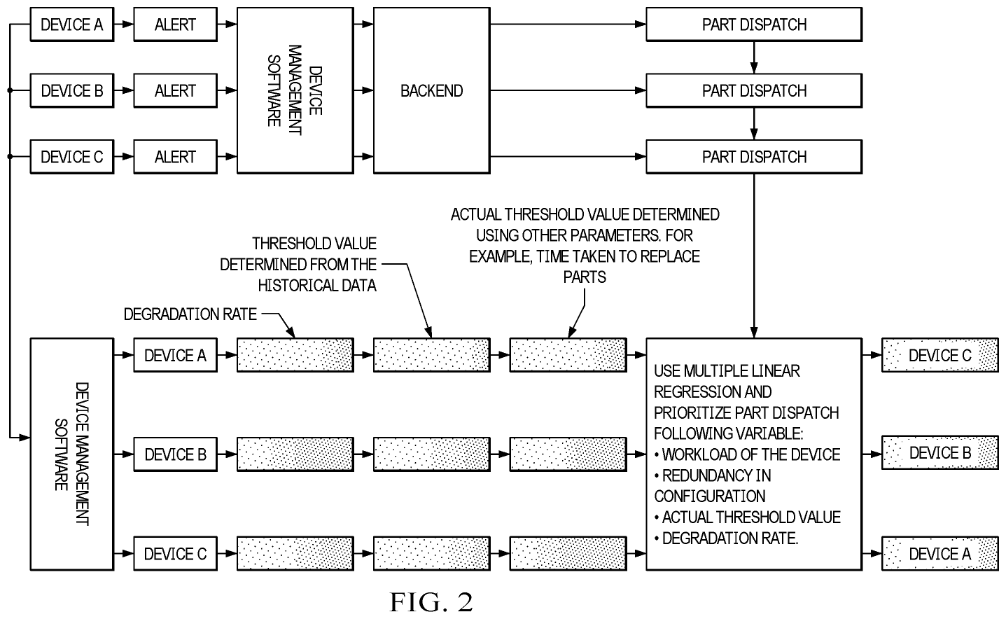

FIG. 2 illustrates a high-level example of how part dispatch may be prioritized in one embodiment. Devices A, B, and C generate an alert that a component needs replacement. The device management software component then uses their respective degradation rates, calculated threshold values, and actual threshold values to perform a multiple linear regression to prioritize the part dispatch for the three devices. In this example, Device B has the most urgent needs, and so its replacement part is dispatched first.

Thus embodiments may include the following high-level stages.

Stage 1. Determine the device degradation rate, which may be calculated using the following steps in one embodiment: decomposition of device into weighted tree; apply weightage policy to the device (including gathering device health descriptors information); calculate rate of change (rate of device degradation).

Stage 2. Determine the modeled device threshold value and the actual threshold value of the device.

Stage 3. Prioritize the part dispatch for the device based on the actual threshold value and other dependent parameters.

In one embodiment, a software agent may execute at the customer site in order to communicate with the manufacturer regarding device problems, device characteristics, etc.

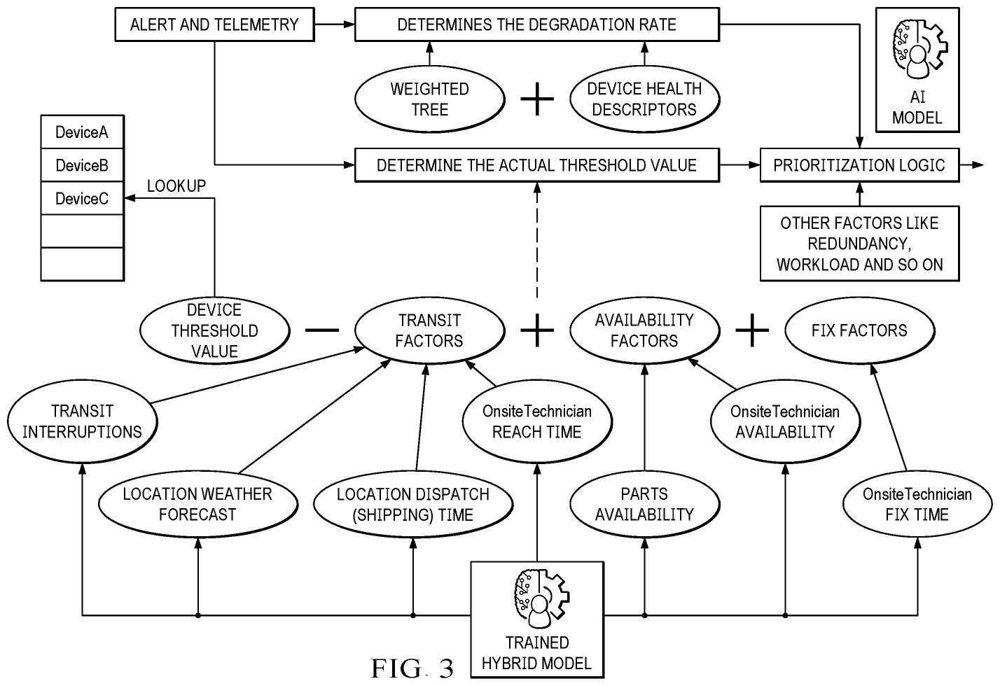

FIG. 3 illustrates how backend components interface with the service environment, according to one embodiment. FIG. 3 also includes transit factors, availability factors, and fix factors, as well as the prioritization logic and integration with existing dispatch systems (e.g., lightning dispatch).

In particular, FIG. 3 illustrates how various real-world factors are combined with the (calculated) device threshold value to determine the actual device threshold value. This computation may rely on a trained hybrid AI model, in some embodiments.

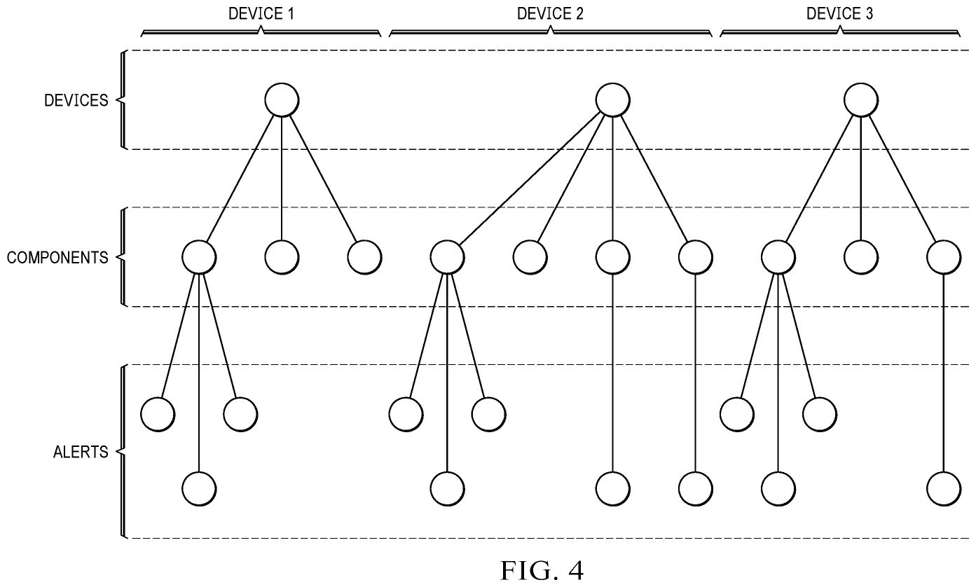

As mentioned above, Stage 1 includes the decomposition of a device into a weighted tree. FIG. 4 illustrates one example. As shown, each device, its components, and its alerts are converted into nodes of a weighed tree. The device is the root node of the tree, the device components are the child nodes, and alerts on each component are the leaf nodes.

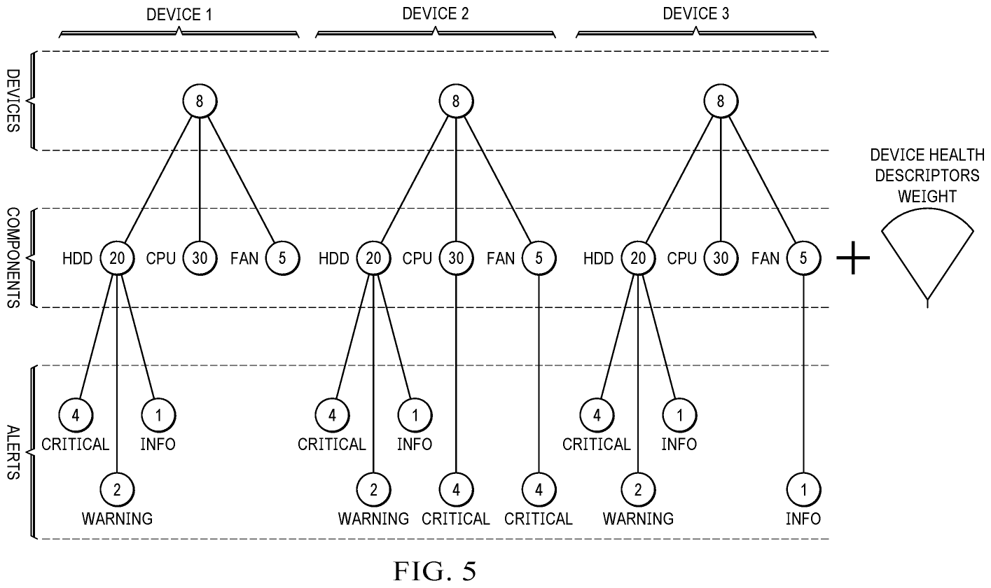

Stage 1 also includes applying a weightage policy to the device's weighted tree. FIG. 5 illustrates one example of how weights may be applied to each node in the scenario of FIG. 4. A policy file with the weights configured (for device, components, and alert types) is applied to the devices which require a dispatch. This policy file and weightage may typically differ based on device type. An example policy file is shown below at Listing 1.

```
{
  “Device”: {
    “customer”: “privileged”,
    “weight”: 8,
    “components”: [
      {
        “name”: “HDD”,
        “weight”: 20
      },
      {
        “name”: “CPU”,
        “weight”: 30
      },
      {
        “name”: “FAN”,
        “weight”: 5
      }
    ]
  },
  “Alerts”: [
    {
      “name”: “warning”,
      “weight”: “2”
    },
    {
      “name”: “critical”,
      “weight”: “4”
    },
    {
      “name”: “Info”,
      “weight”: “1”
    }
  ],
  “DeviceHealthDescriptors”: [
    {
      “name”: “deviceLifeTime”,
      “weight”: 30
    }
  ]
}
```

### Listing 1.

If this policy file is applied to the device as shown in FIG. 5, 8 is assigned as the weight for the device, 30 is assigned as the weight for the component CPU, whereas only 5 is assigned for the fan. Similarly, weight is assigned for alerts based on their severity. An administrator may change the weights and redeploy them based on the requirements of particular situations as well.

Stage 1 also includes gathering the health descriptor information. In the example of storage devices, each storage device has health descriptors and end-of-life information based on wear level count. This information may be used to augment the calculation shown in FIG. 5.

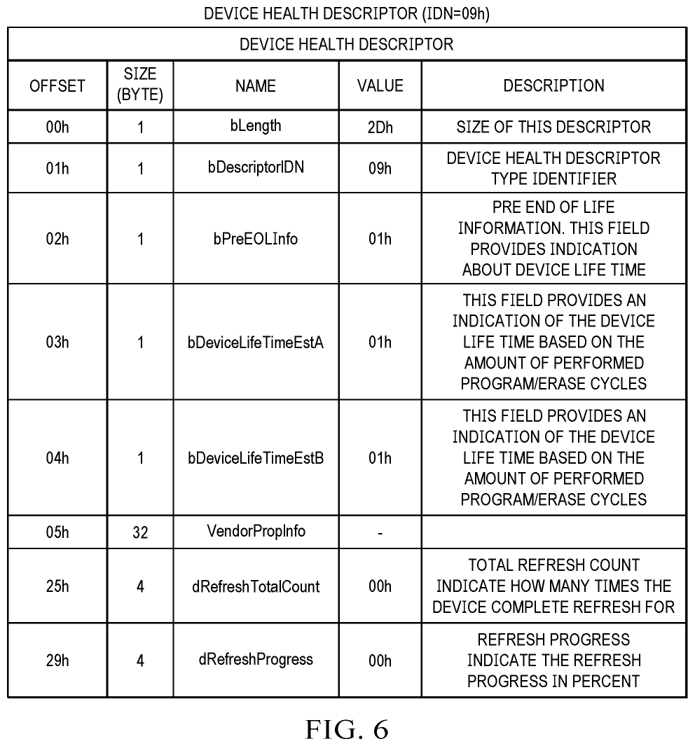

For example, FIG. 6 shows a data set for the device health descriptors for a Universal Flash Storage (UFS) component. Wear leveling count may be set by the storage device controller to show how much life is left in its flash cells. This is a SMART parameter that shows the worst-case erase count of blocks in an SSD device. For example, with the bDeviceLifeTimeEstA, the device lifetime may be offset estimated. This estimate may then be used to determine the rate of degradation. This attribute may be included in the telemetry which is sent from the device to the manufacturer.

Stage 1 further includes calculating the rate of change of device degradation using the weights of the nodes and the device health descriptors. The following steps explain how the rate of change is calculated for Device 1. Similarly, it is calculated for all devices.

1. The weight of all leaf nodes is calculated by adding their weights: 4+2+1=7.

2. The weight of the component branch is calculated by multiplying the total weight of its child nodes (calculated above) by the component weight, that is 7*20=140.

3. The device health descriptors value=device health descriptors weight * offset value, that is 30*10=300.

4. Overall weight of the device is calculated by multiplying the weight of the branch by the device weight+device health descriptors value, that is 8*140=1120+300=1420.

After calculating the overall weight of the device, the rate of the change is calculated using the following formula:

$$Rate of change = ( DW 1 / DW 2 - 1 ) ⋆ 100$$

Where:
DW1=current weight of the device
DW2=previous weight of the device

If the previous weight of Device 1 is 800, the rate of change is ((1420/800)−1)*100=77.5%. Once the rate of change is determined for all devices, the devices may be prioritized based on the rates of degradation in the dispatch planner. An example table of devices is as follows:

| Device Name | State | Rate of change |
|---|---|---|
| Device 1 | Warning | 50% |
| Device 2 | Warning | 35% |
| Device 3 | Warning | 20% |
| Device 4 | Warning | 5% |
| Device 5 | Warning | 2% |
| Device 6 | Healthy | 0% |

Stage 2 includes determining the modeled device threshold value and the actual threshold value. The modeled device threshold value of each device that requires a part dispatch is determined using historical data. Once the device severity or degradation rate is determined for all devices, the manufacturer backend may then determine the total time that will be required to gather, dispatch, and fix the parts using the following parameters, and then the actual threshold value for degradation at which the part dispatch needs to be initiated or prioritized.

1. Time required for the manufacturer to dispatch parts (based on the availability of the parts and model) (t1)

2. Time required for the dispatched part to reach the customer destination (based on the distance) (t2)

3. Time required for the onsite technician to reach the destination (based on their availability) (t3)

4. Time required to replace parts by the technician (based on the number of parts, model to be replaced, plug and play replacement, and/or requirements for additional cabling, soldering, etc.) (t4)

The following formula is then used to determine the total time required to gather parts and fix the parts.

$$TimeToGatherPartsAndFix = PartAvailabilityTime ( t 1 ) + locationDispatchTime ( t 2 ) + onsiteTechnicianReachTime ( t 3 ) + onsiteTechnicianFixTime ( t 4 )$$

Once the total time to gather and fix the part is determined, the following formula is used to determine the actual threshold value for degradation.

Actual threshold value for a device deviceThresholdValue-TimeToGatherPartsAndFix

The following table depicts a real-time example of determining the actual threshold values of the two devices. Two devices (Device A and Device B) of the same model, configuration, and degradation rate need the same part replacement. These devices have the same threshold value for degradation, which is 708. These devices are in different datacenters. Device A is in a remote location, which is far from the manufacturing factory. Device B is in a location which is near to the manufacturing factory.

| | | | | Threshold | Actual |
|---|---|---|---|---|---|
| Device | | | | value per | threshold |
| Name | Model | State | Rate of change | configuration | value |
| Device | X | Warning | 50% | 70% | 50% |
| A | | | | | |
| Device | X | Warning | 35% | 70% | 60% |
| B | | | | | |

The actual threshold value of the Device A and Device B may be calculated as follows:

Device A actual threshold value=deviceThresholdValue (Device A)−degradation value of Device A corresponding to (PartAvailabilityTime+locationDispatchTime+onsiteTechnicianReachTime+onsiteTechnicianFixTime)

$$Device A actual threshold value = 70 \% - ( 2 - 5 - 2 - 2 - 2 )$$

Device A actual threshold value=57%

$$Device B actual threshold value = 70 \% - ( 2 - 5 - 2 - 2 - 2 )$$

Device B actual threshold value=61%

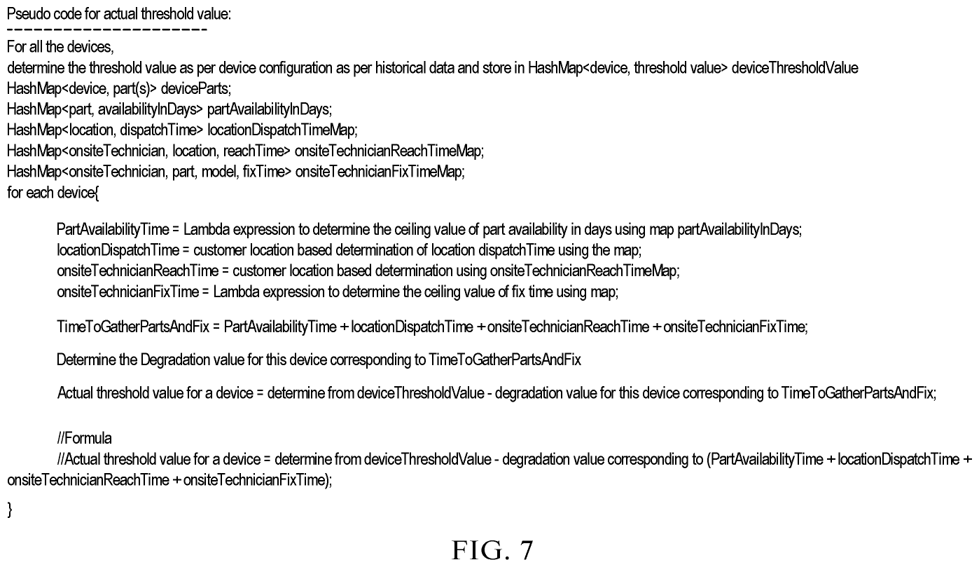

FIG. 7 provides example pseudocode for determining the actual threshold value.

Stage 3 includes prioritizing part dispatch for the device based on the actual threshold value and any other dependent parameters. The manufacturer backend periodically monitors the device and determines the degradation rate of the device that requires dispatch. Until the device degradation rate is less than or equal to the actual threshold value of the device, the prioritization rank may be calculated based on the following parameters using multiple linear regression: workload of the device; redundancy in configuration (e.g., device having redundant disks, etc.); actual threshold value; and degradation rate.

If the device degradation rate approaches or reaches the actual threshold value, the periodic polling frequency may be increased. The prioritization rank of a device part dispatch may be determined using the following formula:

$$Prioritization Rank = β 0 + β 1 + β 2 + β 3 + β 4 + β 4 + ε$$

Where:
β1 is the workload of the device
β2 is the redundancy in configuration
β3 is the actual threshold value
β4 is the degradation rate
ε is an adjustment factor

When the degradation rate of the device meets the actual device threshold value, the manufacturer backend may trigger the part dispatch for the device immediately.

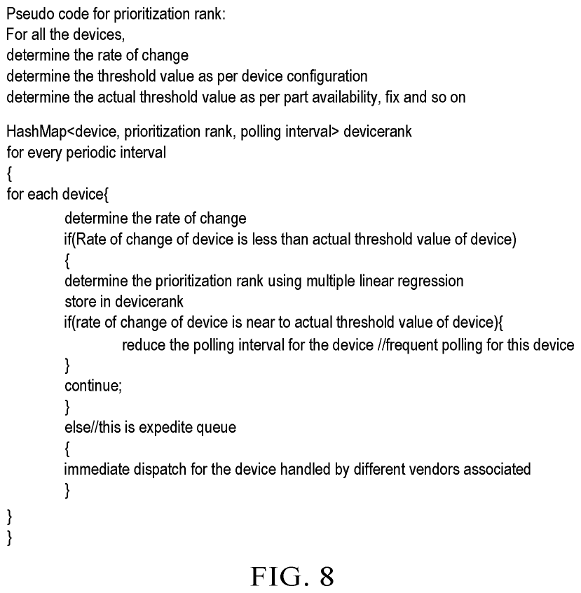

FIG. 8 provides example pseudocode for determining the prioritization rank.

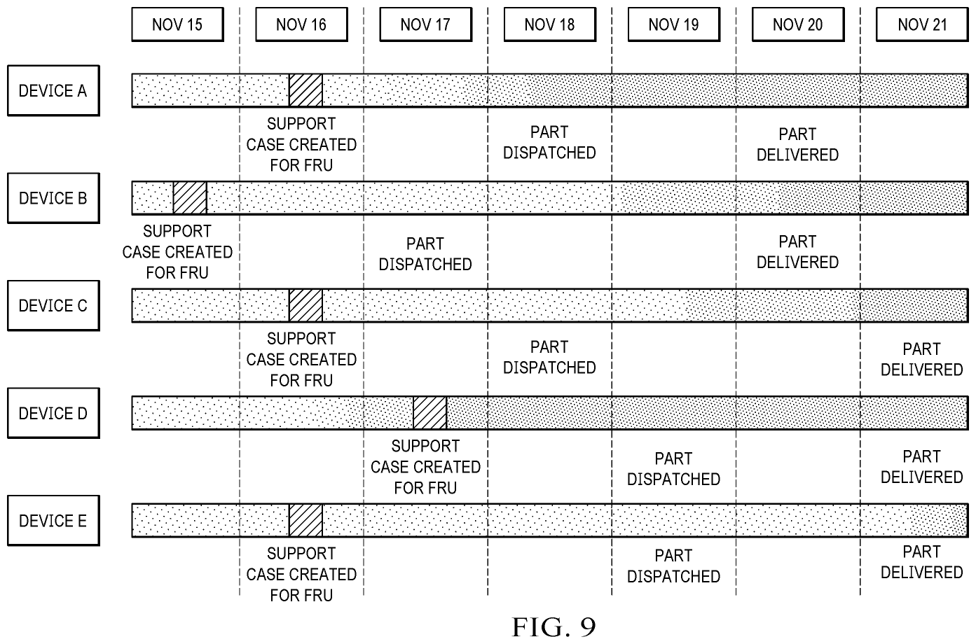

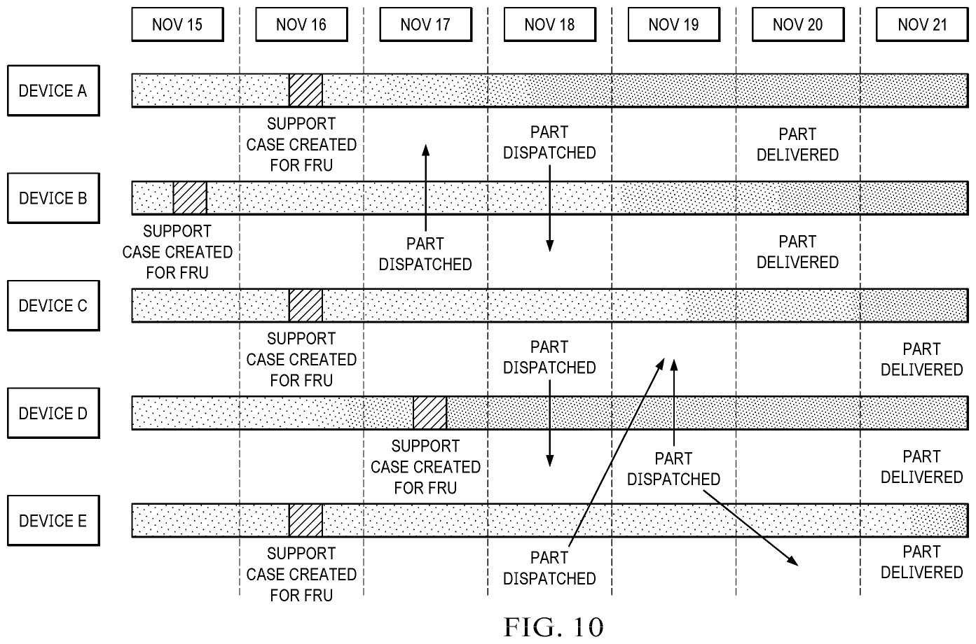

FIGS. 9 and 10 illustrate two possibilities for the journey of five devices that require part replacement (before and after prioritization of parts dispatch, respectively). In this example, all of the other part parameters are the same, and the only deviation between the devices is the degradation rate. In this example, the part dispatch is planned for Device A and Device B on November 18 and November 17, respectively. However, there is a high possibility that Device A will degrade faster than Device B. For this reason, device B's dispatch time is swapped with device A's when taking into account the prioritization techniques of the present disclosure.

The prioritization of dispatch is not restricted only to two devices. The part dispatch may be prioritized for all devices depending on the degradation rate.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory having instructions coded thereon that are executable for:
receiving information regarding dispatch of replacement parts for a plurality of devices;
determining a degradation rate for each device based on a weighted tree for each device, wherein the device is a root node of the weighted tree, wherein components of the device are child nodes of the weighted tree, and wherein alerts associated with each component are leaf nodes of the weighted tree;
determining a device threshold for each device; and
dispatching parts based on the weighted trees and the device thresholds.

2. The information handling system of claim 1, wherein determining the device threshold comprises determining both a modeled device threshold and an actual device threshold.

3. The information handling system of claim 2, wherein the modeled device threshold is based on historical data.

4. The information handling system of claim 2, wherein the actual device thresholds is based on a determination of a time required to dispatch the replacement parts, a time required for the dispatched replacement parts to reach a destination, a time required for a technician to reach the destination, and a time required to install the replacement parts.

5. The information handling system of claim 1, wherein the alerts comprise informational alerts, warning alerts, and critical alerts.

6. The information handling system of claim 1, wherein the degradation rate for a particular device is also based on a health descriptor for the particular device.

7. A method comprising:
an information handling system receiving information regarding dispatch of replacement parts for a plurality of devices;
the information handling system determining a degradation rate for each device based on a weighted tree for each device, wherein the device is a root node of the weighted tree, wherein components of the device are child nodes of the weighted tree, and wherein alerts associated with each component are leaf nodes of the weighted tree;
the information handling system determining a device threshold for each device; and
the information handling system dispatching parts based on the weighted trees and the device thresholds.

8. The method of claim 7, wherein determining the device threshold comprises determining both a modeled device threshold and an actual device threshold.

9. The method of claim 8, wherein the modeled device threshold is based on historical data.

10. The method of claim 8, wherein the actual device thresholds is based on a determination of a time required to dispatch the replacement parts, a time required for the dispatched replacement parts to reach a destination, a time required for a technician to reach the destination, and a time required to install the replacement parts.

11. The method of claim 7, wherein the alerts comprise informational alerts, warning alerts, and critical alerts.

12. The method of claim 7, wherein the degradation rate for a particular device is also based on a health descriptor for the particular device.

13. An article of manufacture comprising a non-transitory, computer-readable medium having computer-executable code thereon that is executable by a processor of an information handling system for:
receiving information regarding dispatch of replacement parts for a plurality of devices;
determining a degradation rate for each device based on a weighted tree for each device, wherein the device is a root node of the weighted tree, wherein components of the device are child nodes of the weighted tree, and wherein alerts associated with each component are leaf nodes of the weighted tree;
determining a device threshold for each device; and
dispatching parts based on the weighted trees and the device thresholds.

14. The article of claim 13, wherein determining the device threshold comprises determining both a modeled device threshold and an actual device threshold.

15. The article of claim 14, wherein the modeled device threshold is based on historical data.

16. The article of claim 14, wherein the actual device thresholds is based on a determination of a time required to dispatch the replacement parts, a time required for the dispatched replacement parts to reach a destination, a time required for a technician to reach the destination, and a time required to install the replacement parts.

17. The article of claim 13, wherein the alerts comprise informational alerts, warning alerts, and critical alerts.

18. The article of claim 13, wherein the degradation rate for a particular device is also based on a health descriptor for the particular device.
